(19) United States
(12) Patent Application Publication
(10) Pub. No.: US 2017/0150041 A1
(43) Pub. Date: May 25, 2017

(54) DOUBLE-EXPOSURE PHOTOGRAPHING METHOD AND APPARATUS OF ELECTRONIC DEVICE

(71) Applicants: LE HOLDINGS (BEIJING) CO., LTD., Beijing (CN); Lemobile Information Technology (Beijing) Co., Ltd., Beijing (CN)

(72) Inventor: Haining HUANG, Beijing (CN)

(21) Appl. No.: 15/232,753

(22) Filed: Aug. 9, 2016

Related U.S. Application Data
(63) Continuation of application No. PCT/CN2016/087338, filed on Jun. 27, 2016.

(30) Foreign Application Priority Data
Nov. 20, 2015 (CN) 201510812715.1

(51) Int. Cl. H04N 5/232; H04N 5/262; H04N 5/235

(52) U.S. Cl. CPC H04N 5/23229; H04N 5/23293; H04N 5/2353; H04N 5/2621

(57) ABSTRACT

An embodiment of the present disclosure discloses a double-exposure photographing method and apparatus of an electronic device, the method comprising: operating a shooting mode of the electronic device; receiving a first photographing instruction; synthesizing the first frame of exposure image data collected by a camera set at a first preset ratio and each frame of exposure image data obtained through live view finding of the camera set at a second preset ratio in real time according to a double exposure algorithm, and displaying synthesized exposure image data on a shooting preview interface; and receiving a second photographing instruction; and synthesizing the first frame of exposure image data at the first preset ratio and the second frame of exposure image data collected by the camera set at the second preset ratio according to the double exposure algorithm, and generating a compressed coded picture according to the synthesized exposure image data.

### CROSS-REFERENCE TO RELATED APPLICATIONS

The present disclosure is a continuation of International Application No. PCT/CN2016/087338 filed on Jun. 27, 2016, which is based upon and claims priority to Chinese Patent Application No. 201510812715.1, entitled “DOUBLE-EXPOSURE PHOTOGRAPHING METHOD AND APPARATUS OF ELECTRONIC DEVICE”, filed Nov. 20, 2015, the entire contents of all of which are incorporated herein by reference.

### FIELD OF TECHNOLOGY

The present disclosure generally relates to the field of electronic devices, and particularly relates to a double-exposure photographing method and apparatus of an electronic device.

### BACKGROUND

Double exposure technology is a photographing technology peculiar to the era of film cameras, and has the theory that double or more exposures (multiple exposures) are performed on the same negative film so that an effect of overlapping two scenes is presented on one photo.

A photographing function now is a standard configuration on a smartphone; however, there is no mature solution for adding the double exposure effect into a camera application of the mobile phone at present. If a user wants to add the double exposure effect to a photo, he/she can only perform double exposure processing by using a post-processing software such as PhotoShop (an image processing software), which is very low in efficiency and has certain losses in photo quality, leading to poor user experience.

### SUMMARY

An embodiment of the present disclosure discloses a double-exposure photographing method and apparatus of an electronic device for the purpose of solving the problems that there is no mature solution for adding a double exposure effect to a camera application of a mobile phone and the double exposure processing performed with a post-processing software is very low in efficiency and has certain losses in photo quality, leading to poor user experience.

According to one aspect of the present disclosure, an embodiment of the present disclosure discloses a double-exposure photographing method of an electronic device, including the following steps: at an electronic device with a camera; operating a shooting mode of the electronic device; receiving a first photographing instruction; acquiring a first frame of exposure image data collected by a camera set, synthesizing the first frame of exposure image data at a first preset ratio and each frame of exposure image data obtained through live view finding of the camera set at a second preset ratio in real time according to a double exposure algorithm, and displaying synthesized exposure image data on a shooting preview interface, a sum of the first preset ratio and the second preset ratio being 1; receiving a second photographing instruction; and acquiring a second frame of exposure image data collected by the camera set, synthesizing the first frame of exposure image data at the first preset ratio and the second frame of exposure image data at the second preset ratio according to the double exposure algorithm, and generating a compressed coded picture according to synthesized exposure image data.

According to another aspect of the present disclosure, an embodiment of the present disclosure also discloses a double-exposure photographing apparatus of an electronic device, including: an operating module for operating a shooting mode of the electronic device; a first instruction receiving module for receiving a first photographing instruction; a display module for acquiring a first frame of exposure image data collected by a camera set, synthesizing the first frame of exposure image data at a first preset ratio and each frame of exposure image data obtained through live view finding of the camera set at a second preset ratio in real time according to a double exposure algorithm, and displaying synthesized exposure image data on a shooting preview interface, a sum of the first preset ratio and the second preset ratio being 1; a second instruction receiving module for receiving a second photographing instruction; and an image generating module for acquiring a second frame of exposure image data collected by the camera set, synthesizing the first frame of exposure image data at the first preset ratio and the second frame of exposure image data at the second preset ratio according to the double exposure algorithm, and generating a compressed coded picture according to synthesized exposure image data.

According to yet another aspect of the present disclosure, there is provided a computer program, including a computer readable code, the operating of the computer readable code on an electronic device leading to that the electronic device executes the method as described above.

According to still another aspect of the present disclosure, there is provided a computer readable medium, in which the computer program as described above is stored.

The present disclosure has the following advantageous effects:

according to the double-exposure photographing method and apparatus of the electronic device provided by the embodiment of the present disclosure, after the shooting mode of the electronic device is operated, the first photographing instruction is first received the first frame of exposure image data collected by the camera set is further acquired, the first frame of exposure image data at the first preset ratio and each frame of exposure image data obtained through live view finding of the camera set at the second preset ratio are synthesized in real time according to the double exposure algorithm, and the synthesized exposure image data are displayed on the shooting preview interface; and after the second photographing instruction is received, the second frame of exposure image data collected by the camera set is acquired, the first frame of exposure image data at the first preset ratio and the second frame of exposure image data at the second preset ratio are synthesized according to the double exposure algorithm, and the compressed coded picture is generated according to the synthesized exposure image data. Therefore, the double exposure effect is introduced into photographing by starting from a camera function of the electronic device directly, so that when a user takes a photo, the shooting preview interface and the finished photo directly present the double exposure effect, which is visual and efficient; and in addition, since each frame of exposure image data collected by the camera set without being compressed and coded and each frame of exposure image data subjected to view finding are processed directly, the image pixels and the preview smoothness can be maximally prevented from being lost.

The foregoing illustration is only an overview of a technical solution to the present disclosure. A technical means of the present disclosure can be more fully practiced in accordance with the description; and the above and other objects, features and other advantages of the present disclosure will be more clearly understood from the following detailed description.

### BRIEF DESCRIPTION OF THE DRAWINGS

In order to more clearly illustrate the technical solution in an embodiment of the present disclosure or the prior art, drawings required to be used in the description of the embodiment or the prior art will be briefly introduced in the following; it is obvious that the drawings described in the following are only related to some embodiments of the present disclosure. Other drawings may be obtained according to these drawings by those ordinarily skilled in the art without undertaking creative work.

FIG. 1 is a flowchart of the steps of an embodiment of a double-exposure photographing method of an electronic device of the present disclosure.

FIG. 2 is a flowchart of the steps of another embodiment of a double-exposure photographing method of an electronic device of the present disclosure.

FIG. 3 is a block diagram of a structure of an embodiment of a double-exposure photographing apparatus of an electronic device of the present disclosure.

FIG. 4 is a block diagram of a structure of another embodiment of a double-exposure photographing apparatus of an electronic device of the present disclosure.

FIG. 5 is a schematic diagram of a process of processing a first frame of exposure image data by a particular embodiment of a double-exposure photographing apparatus of an electronic device of the present disclosure.

FIG. 6 is a schematic diagram of a process of processing a second frame of exposure image data by a particular embodiment of a double-exposure photographing apparatus of an electronic device of the present disclosure.

FIG. 7 shows schematically a block diagram of an electronic device for executing a method according to the present disclosure.

FIG. 8 shows schematically a storage unit for maintaining or carrying a program code for implementing a method according to the present disclosure.

### DESCRIPTION OF THE EMBODIMENTS

For the purpose of making objects, technical solutions and advantages of embodiments of the present disclosure more clear, clear and complete description will be made to technical solutions of the present disclosure in conjunction with corresponding drawings in the embodiment of the present disclosure. Obviously, the described embodiments are merely a part of the embodiments of the present disclosure and not all the embodiments. Based on the embodiments of the present disclosure, all other embodiments obtained by those ordinarily skilled in the art without paying creative work fall within the protection scope of the present disclosure.

An electronic device in an embodiment of the present disclosure may be a mobile phone, a camera, a notebook computer or a tablet computer and other electronic devices having a photographing function.

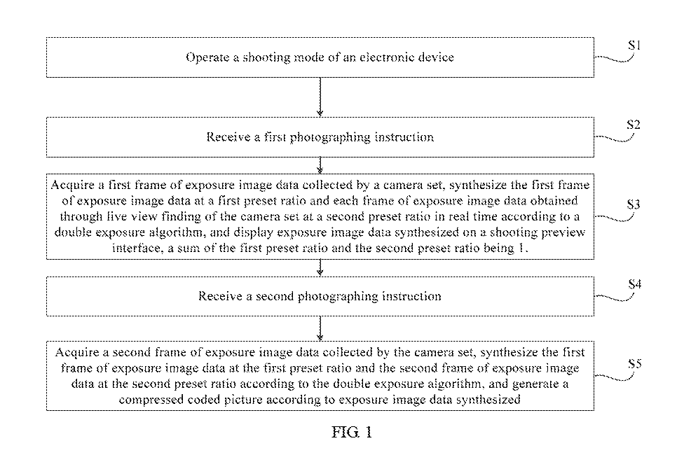

With reference to FIG. 1, it shows a flowchart of steps of an embodiment of a double-exposure photographing method of an electronic device of the present disclosure. The double-exposure photographing method of the electronic device may include the steps as follows.

S1, operate a shooting mode of the electronic device.

Wherein after a user enables a camera function of the electronic device, the step S is conducted to operate the photographing mode of the electronic device.

S2, receive a first photographing instruction.

After the user clicks a photographing button for the first time, the step S2 is conducted to receive a first photographing instruction.

S3, acquire a first frame of exposure image data collected by a camera set, synthesize the first frame of exposure image data at a first preset ratio and each frame of exposure image data obtained through live view finding of the camera set at a second preset ratio in real time according to a double exposure algorithm, and display synthesized exposure image data on a shooting preview interface, a sum of the first preset ratio and the second preset ratio being 1.

Wherein the camera set may include a camera, an analog-digital conversion module and the like. When the electronic device includes double cameras, the camera in the camera set in the step S3 may be a front camera or a rear camera. Specifically, when the user enables the camera function, the camera set of the electronic device performs live view finding. i.e. receiving light information, and performs pre-processing such as analog-digital conversion on the received light information to obtain exposure image data. Wherein after the step S2, the camera set collects the light information and performs pre-processing such as analog-digital conversion on the collected light information to obtain the first frame of exposure image data. Wherein the first frame of exposure image data may be image data in the format of YUV (YCrCb, which is a color coding method adopted by the European television system), or RGB (representing the colors of three channels of red, green and blue), or others.

Specifically, in the step S3, transparency processing may be performed on the first frame of exposure image data according to the double exposure algorithm through a software system of the electronic device to obtain image data with the transparency of the first preset ratio (which can be preset by a user as required).

Specifically, after the step S3 of acquiring the first frame of exposure image data collected by the camera set, the camera set continues to perform live view finding, i.e. continuing to receive the light information, and performs pre-processing such as analog-digital conversion on the received light information to obtain each frame of exposure image data subjected to view finding in the step S3. Wherein each frame of exposure image data subjected to view finding in the step S3 may be image data in the format of YUV, RGB or others.

Specifically, in the step S3, transparency processing may be performed on each frame of exposure image data subjected to live view finding of the camera set according to the double exposure algorithm through a software system of the electronic device to obtain image data with the transparency of the second preset ratio; further, the first frame of exposure image data subjected to the transparency processing and each frame of exposure image data obtained through live view finding of the camera set and subjected to the transparency processing are synthesized in real time according to the double exposure algorithm, and then synthesized exposure image data are displayed on the shooting preview interface which may present a double exposure effect in real time. Therefore, the picture pixels can be maximally prevented from being lost; and moreover, since the software system is high in processing efficiency, the preview smoothness is prevented from being lost, thereby greatly increasing the user experience.

S4, receive a second photographing instruction.

Specifically, after the user determines the current double exposure effect to be the required double exposure effect according to the shooting preview interface, the step S4 is conducted to receive the second photographing instruction if the user clicks the photographing button for the second time.

S5, acquire a second frame of exposure image data collected by the camera set, synthesize the first frame of exposure image data at the first preset ratio and the second frame of exposure image data at the second preset ratio according to the double exposure algorithm, and generate a compressed coded picture according to synthesized exposure image data.

Wherein when the electronic device includes a double cameras, the camera in the camera set in the step S5 may be a front camera or a rear camera. Specifically, after the step S4, the camera set collects the light information and performs pre-processing such as analog-digital conversion on the collected light information to obtain the second frame of exposure image data. Wherein the second frame of exposure image data may be image data in the format of YUV. RGB or others.

Specifically, in the step S5, transparency processing may be performed on the second frame of exposure image data according to the double exposure algorithm through a software system of the electronic device to obtain image data with the transparency of the second preset ratio, and further, the first frame of exposure image data subjected to the transparency processing and the second frame of exposure image data subjected to the transparency processing are synthesized. In addition, in the step S5, the synthesized exposure image data may be compressed and coded into a picture in a preset format through the software system, and the picture is the picture with the current double exposure effect as described above. Specifically, the preset format may be a format of JPEG (Joint Photographic Experts Group), GIF (Graphics Interchange Format) or PNG (Portable Network Graphic Format) and others.

Since the first frame of exposure image data and the second frame of exposure image data, which are collected by the camera set and are not compressed and coded, are subjected to double exposure synthesis, and the synthesized exposure image data are then compressed and coded in the step S5, the picture pixels can be maximally prevented from being lost, and the user experience is greatly increased.

According to Embodiment 1 of the present disclosure, after the shooting mode of the electronic device is operated, the first photographing instruction is first received; the first frame of exposure image data collected by the camera set is further acquired, the first frame of exposure image data at the first preset ratio and each frame of exposure image data obtained through live view finding of the camera set at the second preset ratio are synthesized in real time according to the double exposure algorithm, and the synthesized exposure image data are displayed on the shooting preview interface; after the second photographing instruction is received, the second frame of exposure image data collected by the camera set is acquired, the first frame of exposure image data at the first preset ratio and the second frame of exposure image data at the second preset ratio are synthesized according to the double exposure algorithm, and the compressed coded picture is generated according to the synthesized exposure image data. Therefore, the double exposure effect is introduced into photographing by starting from the camera function of the electronic device directly, so that when a user takes a photo, the shooting preview interface and the finished photo directly present the double exposure effect, which is visual and efficient; and in addition, since each frame of exposure image data collected by the camera set without being compressed and coded and each frame of exposure image data subjected to view finding are processed directly through the software system, the image pixels and the preview smoothness can be maximally prevented from being lost, thereby increasing the user experience.

### Embodiment 2

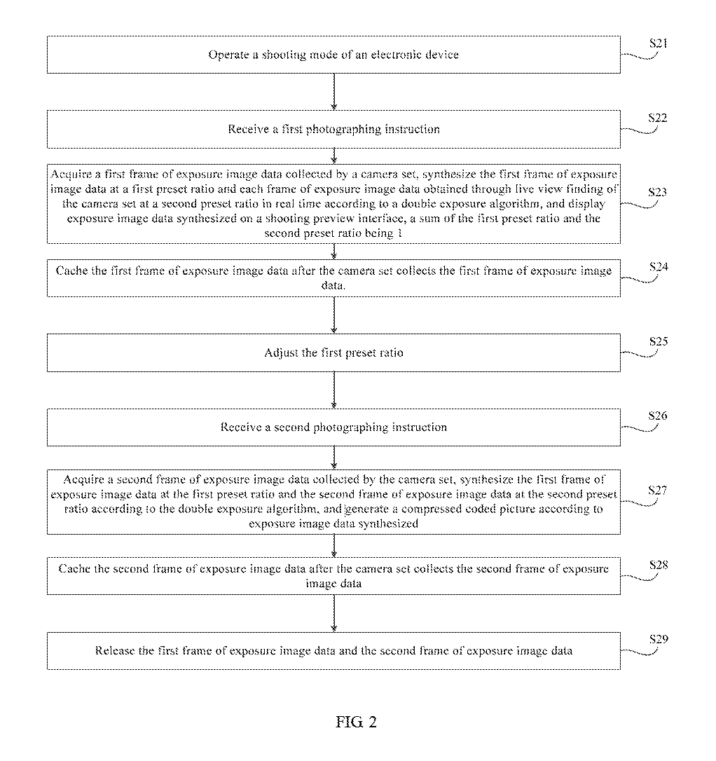

With reference to FIG. 2, it shows a flowchart of steps of another embodiment of a double-exposure photographing method of an electronic device of the present disclosure. The double-exposure photographing method of the electronic device may include the steps as follows.

S21, operate a shooting mode of the electronic device.

Wherein after a user enables a camera function of the electronic device, the step S21 is conducted to operate the photographing mode of the electronic device.

S22, receive a first photographing instruction.

After the user clicks a photographing button for the first time, the step S22 is conducted to receive a first photographing instruction.

S23, acquire a first frame of exposure image data collected by a camera set, synthesize the first frame of exposure image data at a first preset ratio and each frame of exposure image data obtained through live view finding of the camera set at a second preset ratio in real time according to a double exposure algorithm, and display synthesized exposure image data on a shooting preview interface, a sum of the first preset ratio and the second preset ratio being 1.

Wherein the camera set may include a camera, an analog-digital conversion module and the like. When the electronic device includes double cameras, the camera in the camera set in the step S23 may be a front camera or a rear camera. Specifically, when the user enables the camera function, the camera set of the electronic device performs live view finding, i.e. receiving light information, and performs pre-processing such as analog-digital conversion on the received light information to obtain exposure image data. Wherein after the step S22, the camera set collects the light information and performs pre-processing such as analog-digital conversion on the collected light information to obtain the first frame of exposure image data. Wherein the first frame of exposure image data may be image data in the format of YUV. RGB or others.

Specifically, in the step S23, transparency processing may be performed on the first frame of exposure image data according to the double exposure algorithm through a software system of the electronic device to obtain image data with the transparency of the first preset ratio (which can be preset by the user as required).

Specifically, after the step S23 of acquiring the first frame of exposure image data collected by the camera set, the camera set continues to perform live view finding, i.e. continuing to receive the light information, and performs pre-processing such as analog-digital conversion on the received light information to obtain each frame of exposure image data subjected to view finding in the step S23. Wherein each frame of exposure image data subjected to view finding in the step S23 may be image data in the format of YUV, RGB or others.

Specifically, in the step S23, transparency processing may be performed on each frame of exposure image data subjected to live view finding of the camera set according to the double exposure algorithm through a software system of the electronic device to obtain image data with the transparency of the second preset ratio; further, the first frame of exposure image data subjected to the transparency processing and each frame of exposure image data obtained through live view finding of the camera set and subjected to the transparency processing are synthesized in real time according to the double exposure algorithm, and then synthesized exposure image data are displayed on the shooting preview interface, which may present a double exposure effect in real time. Therefore, the picture pixels can be maximally prevented from being lost, moreover, since the software system is high in processing efficiency, the preview smoothness is prevented from being lost, thereby greatly increasing the user experience.

S24, cache the first frame of exposure image data after the camera set collects the first frame of exposure image data.

Wherein in the step S24, the first frame of exposure image data can be cached into a system memory so that the software system can process the first frame of exposure image data efficiently.

S25, adjust the first preset ratio.

Wherein the user may freely set the first preset ratio through a ratio adjusting button or a ratio selecting list and the like on the shooting preview interface, therefore, the step S25 is conducted correspondingly to adjust the first preset ratio, thereby adjusting the proportion of the double exposure of the first frame of exposure image data in the final finished photo.

S26, receive a second photographing instruction.

Specifically, after the user determines the current double exposure effect to be the required double exposure effect according to the shooting preview interface, the step S26 is conducted to receive the second photographing instruction if the user clicks the photographing button for the second time.

S27, acquire a second frame of exposure image data collected by the camera set, synthesize the first frame of exposure image data at the first preset ratio and the second frame of exposure image data at the second preset ratio according to the double exposure algorithm, and generate a compressed coded picture according to synthesized exposure image data.

Wherein when the electronic device includes double cameras, the camera in the camera set in the step S27 may be a front camera or a rear camera. Specifically, after the step S26, the camera set collects the light information and performs pre-processing such as analog-digital conversion on the collected light information to obtain the second frame of exposure image data. Wherein the second frame of exposure image data may be image data in the format of YUV, RGB or others.

Specifically, in the step S27, transparency processing may be performed on the second frame of exposure image data according to the double exposure algorithm through a software system of the electronic device to obtain image data with the transparency of the second preset ratio, and further, the first frame of exposure image data subjected to the transparency processing and the second frame of exposure image data subjected to the transparency processing are synthesized. In addition, in the step S27, the synthesized exposure image data may be compressed and coded into a picture in a preset format through the software system, and the picture is a picture with the current double exposure effect as described above. Specifically, the preset format may be the format of JPEG; GIF, PNG and others.

Since the first frame of exposure image data and the second frame of exposure image data, which are collected by the camera set and are not compressed and coded, are subjected to double exposure synthesis and the synthesized exposure image data are then compressed and coded in the step S27, the picture pixels can be maximally prevented from being lost, and the user experience is greatly increased.

S28, cache the second frame of exposure image data after the camera set collects the second frame of exposure image data.

In the step S28, the second frame of exposure image data can be cached into a system memory so that the software system can process the second frame of exposure image data efficiently.

S29, release the first frame of exposure image data and the second frame of exposure image data.

Wherein after the step S24 of caching the first frame of exposure image data into the system memory and the step S28 of caching the second frame of exposure image data into the system memory, the step S29 can be conducted to release the system memory occupied by the first frame of exposure image data and the second frame of exposure image data, thereby improving system efficiency.

Specifically, the double exposure algorithm as described above may include a calculation formula as follows:

P=M*P1+(1−M)*P2

wherein P is the synthesized exposure image data, P1 is the first frame of exposure image data, P2 is the second frame of exposure image data or each frame of exposure image data obtained through live view finding of the camera set, M is the first preset ratio, and (1−M) is the second preset ratio, wherein 0<M<1.

According to Embodiment 2 of the present disclosure, after the shooting mode of the electronic device is operated, the first photographing instruction is received, the first frame of exposure image data collected by the camera set is further acquired, the first frame of exposure image data at the first preset ratio and each frame of exposure image data obtained through live view finding of the camera set at the second preset ratio are synthesized in real time according to the double exposure algorithm, and the synthesized exposure image data are displayed on the shooting preview interface, wherein when the camera set collects the first frame of exposure image data, the first frame of exposure image data is cached and the first preset ratio is further adjusted. Furthermore, after the second photographing instruction is received, the second frame of exposure image data collected by the camera set is acquired, the first frame of exposure image data at the first preset ratio and the second frame of exposure image data at the second preset ratio are synthesized according to the double exposure algorithm, and the compressed and coded picture is generated according to the synthesized exposure image data, wherein after the camera set collects the second frame of exposure image data, the second frame of exposure image data is cached. Therefore, the double exposure effect is introduced into photographing by starting from the camera function of the electronic device directly, so that when the user takes a photo, the shooting preview interface and the finished photo directly present the double exposure effect, and the user can freely set the proportion of the double exposure in the final finished photo, which is visual and efficient; and in addition, since each frame of exposure image data collected by the camera set without being compressed and coded and each frame of exposure image data subjected to view finding are processed directly through the software system, the image pixels and the preview smoothness can be maximally prevented from being lost, thereby increasing the user experience.

### Embodiment 3

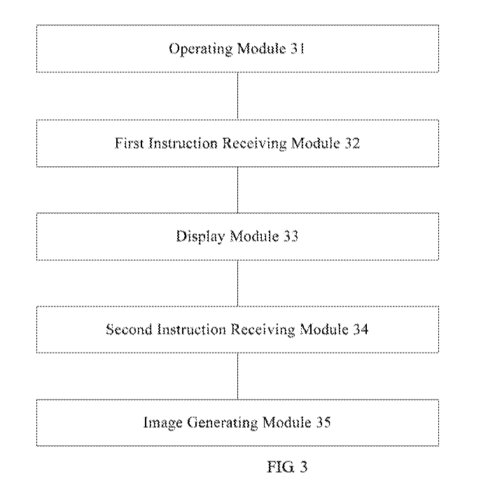

With reference to FIG. 3, it illustrates a block diagram of a structure of an embodiment of a double-exposure photographing apparatus of an electronic device of the present disclosure. The double-exposure photographing apparatus of the electronic device may include:

an operating module 31 for operating a shooting mode of the electronic device;

a first instruction receiving module 32 for receiving a first photographing instruction;

a display module 33 for acquiring a first frame of exposure image data collected by a camera set, synthesizing the first frame of exposure image data at a first preset ratio and each frame of exposure image data obtained through live view finding of the camera set at a second preset ratio in real time according to a double exposure algorithm, and displaying synthesized exposure image data on a shooting preview interface, a sum of the first preset ratio and the second preset ratio being 1:

a second instruction receiving module 34 for receiving a second photographing instruction; and

an image generating module 35 for acquiring a second frame of exposure image data collected by the camera set, synthesizing the first frame of exposure image data at the first preset ratio and the second frame of exposure image data at the second preset ratio according to the double exposure algorithm, and generating a compressed coded picture according to synthesized exposure image data.

According to Embodiment 3 of the present disclosure, after the operating module operates the shooting mode of the electronic device, the first photographing instruction receiving module first receives the first photographing instruction; the display module further acquires the first frame of exposure image data collected by the camera set, synthesizes the first frame of exposure image data at the first preset ratio and each frame of exposure image data obtained through live view finding of the camera set at the second preset ratio in real time according to the double exposure algorithm, and displays the synthesized exposure image data on the shooting preview interface. Furthermore, after the second instruction receiving module receives the second photographing instruction, the image generating module acquires the second frame of exposure image data collected by the camera set, synthesizes the first frame of exposure image data at the first preset ratio and the second frame of exposure image data at the second preset ratio according to the double exposure algorithm, and generates the compressed coded picture according to the synthesized exposure image data. Therefore, the double exposure effect is introduced into photographing by starting from the camera function of the electronic device directly, so that when a user takes a photograph, the shooting preview interface and the finished photograph directly present the double exposure effect, which is visual and efficient; and in addition, since each frame of exposure image data collected by the camera set without being compressed and coded and each frame of exposure image data subjected to view finding are processed directly through the software system, the image pixels and the preview smoothness can be maximally prevented from being lost, thereby increasing the user experience.

### Embodiment 4

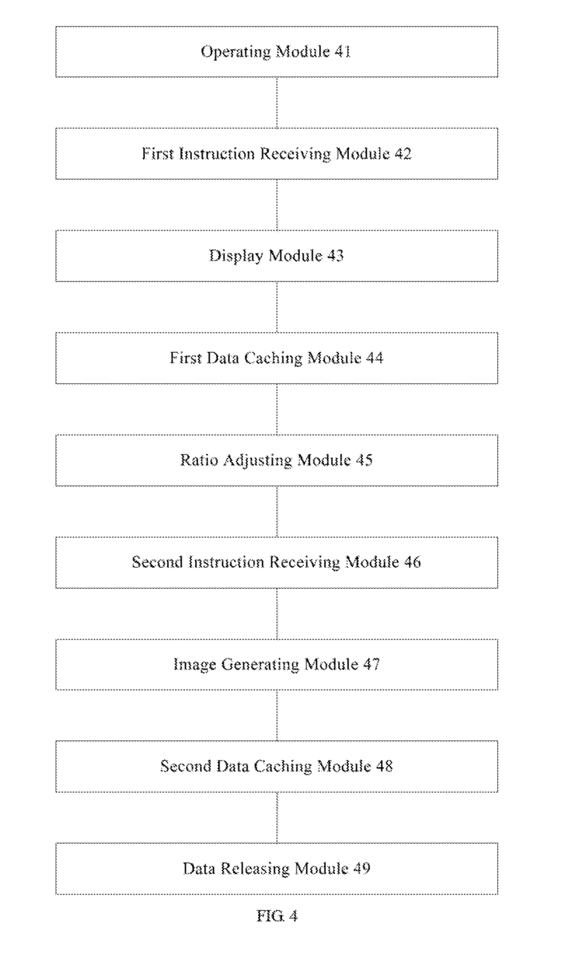

With reference to FIG. 4, it illustrates a block diagram of a structure of another embodiment of a double-exposure photographing apparatus of an electronic device of the present disclosure. The double-exposure photographing apparatus of the electronic device may include:

an operating module 41 for operating a shooting mode of the electronic device:

a first instruction receiving module 42 for receiving a first photographing instruction;

a display module 43 for acquiring a first frame of exposure image data collected by a camera set, synthesizing the first frame of exposure image data at a first preset ratio and each frame of exposure image data obtained through live view finding of the camera set at a second preset ratio in real time according to a double exposure algorithm, and displaying synthesized exposure image data on a shooting preview interface, a sum of the first preset ratio and the second preset ratio being 1;

a first data caching module 44 for caching the first frame of exposure image data after the camera set collects the first frame of exposure image data;

a ratio adjusting module 45 for adjusting the first preset ratio;

a second instruction receiving module 46 for receiving a second photographing instruction;

an image generating module 47 for acquiring a second frame of exposure image data collected by the camera set, synthesizing the first frame of exposure image data at the first preset ratio and the second frame of exposure image data at the second preset ratio according to the double exposure algorithm, and generating a compressed coded picture according to synthesized exposure image data;

a second data caching module 48 for caching the second frame of exposure image data after the camera set collects the second frame of exposure image data; and

a data releasing module 49 for releasing the first frame of exposure image data and the second frame of exposure image data.

Specifically, the double exposure algorithm as described above may include a calculation formula as follows:

P=M*P1+(1−M)*P2

wherein P is the synthesized exposure image data, P1 is the first frame of exposure image data, P2 is the second frame of exposure image data or each frame of exposure image data obtained through live view finding of the camera set in real time, M is the first preset ratio, and (1−M) is the second preset ratio, wherein 0<M<1.

In a particular embodiment of the present disclosure, the electronic device is a mobile phone, with reference to FIG. 5, after a camera set 1 of the mobile phone collects a first frame of exposure image data 2, a first data caching module 44 first caches the first frame of exposure image data 2, a display module 43 performs transparency processing on the first frame of exposure image data 2 according to a double exposure algorithm through a software system 3 to obtain image data 4 with the transparency of 50% (the first preset ratio) without JPEG compressing and coding as well as uploading.

Thereafter, the camera set 1 continues to perform live view finding, the display module 43 performs transparency processing on each frame of exposure image data subjected to view finding according to the double exposure algorithm through a software system 3 to obtain image data with the transparency of 50% (the second preset ratio); further, the first frame of exposure image data subjected to the transparency processing and each frame of exposure image data obtained through live view finding of the camera set and subjected to the transparency processing are synthesized in real time according to the double exposure algorithm, and then synthesized exposure image data are displayed on the shooting preview interface; and, in the meantime, the user may adjust the first preset ratio through the ratio adjusting module 45.

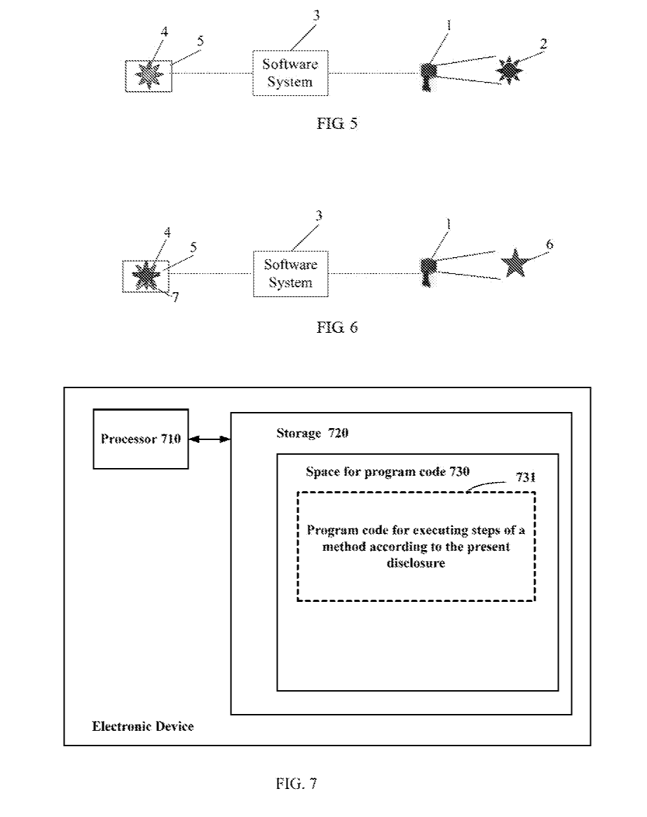

After determining the current double exposure effect to be the required double exposure effect according to a shooting preview interface 5, the user clicks the photographing button; with reference to FIG. 6, the camera set 1 collects a second frame of exposure image data 6, a second data caching module 48 caches the second frame of exposure image data 6, an image generating module 47 performs transparency processing on the second frame of exposure image data 6 according to the double exposure algorithm through the software system 3 to obtain the image data with the transparency of 50% (the second preset ratio) without JPEG compressing and coding as well as uploading, the first frame of exposure image data 2 subjected to transparency processing and the second frame of exposure image data 6 subjected to the transparency processing are synthesized according to the double exposure algorithm, the synthesized exposure image data are compressed and coded into a picture in the format of JPEG and a camera APP is notified to save the picture for finishing the photographing. Wherein the image data 4 with the transparency of 50% are displayed in the shooting preview interface 5 of the camera APP as shown in FIG. 5 and FIG. 6.

According to Embodiment 4 of the present disclosure, after the operating module operates the shooting mode of the electronic device, the first instruction receiving module receives the first photographing instruction; the display module further acquires the first frame of exposure image data collected by the camera set, synthesizes the first frame of exposure image data at the first preset ratio and each frame of exposure image data obtained through live view finding of the camera set at the second preset ratio in real time according to the double exposure algorithm, and displays the exposure image data on the shooting preview interface, wherein when the camera set collects the first frame of exposure image data, the first data caching module caches the first frame of exposure image data, and the ratio adjusting module further adjusts the first preset ratio. Furthermore, after the second instruction receiving module receives the second photographing instruction, the image generating module acquires the second frame of exposure image data collected by the camera set, synthesizes the first frame of exposure image data at the first preset ratio and the second frame of exposure image data at the second preset ratio according to the double exposure algorithm, and generates the compressed coded picture according to the synthesized exposure image data, wherein after the camera set collects the second frame of exposure image data, the second data caching module caches the second frame of exposure image data. Therefore, the double exposure effect is introduced into photographing by starting from the camera function of the electronic device directly, so that when a user takes a photograph, the shooting preview interface and the finished photo directly present the double exposure effect, and the user can freely set the proportion of the double exposure in the final finished photograph, which is visual and efficient; and in addition, since each frame of exposure image data collected by the camera set without being compressed and coded and each frame of exposure image data subjected to view finding are processed directly through the software system, the image pixels and the preview smoothness can be maximally prevented from being lost, thereby increasing the user experience.

Apparatus embodiments described above are illustrative only, wherein the unit described as a separate part may be or may not be physically separated, a part displayed as the unit may be or may not be a physical unit, may be located in one place, or may be distributed on a plurality of network units. Some or all of the modules may be selected to achieve the objective of the solutions of the embodiments according to actual requirements. Those ordinarily skilled in the art may understand and implement it without undertaking creative works.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

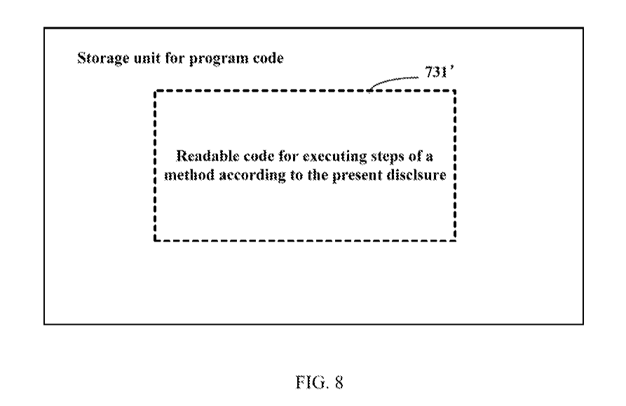

For example, FIG. 7 illustrates a block diagram of an electronic device for executing the method according the disclosure. Traditionally, the electronic device includes a processor 710 and a computer program product or a computer readable medium in form of a memory 720. The memory 720 could be electronic memories such as flash memory, EEPROM (Electrically Erasable Programmable Read—Only Memory), EPROM, hard disk or ROM. The memory 720 has a memory space 730 for executing program codes 731 of any steps in the above methods. For example, the memory space 730 for program codes may include respective program codes 731 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 8. The memory cells may be provided with memory sections, memory spaces, etc., similar to the memory 720 of the server as shown in FIG. 7. The program codes may be compressed for example in an appropriate form. Usually, the memory cell includes computer readable codes 731′ which can be read for example by processors 710. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”. “second”, and “third”. etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it should be noted that the foregoing embodiments are merely illustrative of technical solutions of the present disclosure without limitation; although the present disclosure is illustrated in detail with reference to the above embodiments, those ordinarily skilled in the art will appreciate that modifications may be made on the technical solutions cited by the above embodiments, or equivalent substitutions may be made on partial technical features; moreover, these modifications or substitutions will not make the essential of corresponding technical solutions depart from the spirit and scope of the technical solutions in respective embodiments of the present disclosure.

What is claimed is:

1. A double-exposure photographing method of an electronic device, comprising:
at an electronic device with a camera;
operating shooting mode of the electronic device;
receiving a first photographing instruction;
acquiring a first frame of exposure image data collected by a camera set, synthesizing the first frame of exposure image data at a first preset ratio and each frame of exposure image data obtained through live view finding of the camera set at a second preset ratio in real time according to a double exposure algorithm, and displaying synthesized exposure image data on a shooting preview interface, a sum of the first preset ratio and the second preset ratio being 1;
receiving a second photographing instruction; and
acquiring a second frame of exposure image data collected by the camera set, synthesizing the first frame of exposure image data at the first preset ratio and the second frame of exposure image data at the second preset ratio according to the double exposure algorithm, and generating a compressed coded picture according to the synthesized exposure image data.

2. The method according to claim 1, further comprising:
caching the first frame of exposure image data after the camera set collects the first frame of exposure image data; and
caching the second frame of exposure image data after the camera set collects the second frame of exposure image data.

3. The method according to claim 2, wherein after generating a compressed coded picture according to the synthesized exposure image data, further comprising:
releasing the first frame of exposure image data and the second frame of exposure image data.

4. The method according to claim 1, wherein before the receiving a second photographing instruction, the method further comprises:
adjusting the first preset ratio.

5. The method according to claim 1, wherein the double exposure algorithm comprises a calculation formula as follows:
P=M*P1+(1−M)*P2
wherein P is the synthesized exposure image data, P1 is the first frame of exposure image data, P2 is the second frame of exposure image data or each frame of exposure image data obtained through live view finding of the camera set in real time, M is the first preset ratio, and (1−M) is the second preset ratio, wherein 0<M<1.

6. An electronic device for double-exposure photographing, comprising:
a memory having instructions stored thereon;
a processor configured to execute the instructions to perform operations for processing double-exposure photographing, comprising:
operating a shooting mode of the electronic device;
receiving a first photographing instruction;
acquiring a first frame of exposure image data collected by a camera set, synthesizing the first frame of exposure image data at a first preset ratio and each frame of exposure image data obtained through live view finding of the camera set at a second preset ratio in real time according to a double exposure algorithm, and displaying synthesized exposure image data on a shooting preview interface, a sum of the first preset ratio and the second preset ratio being 1;
receiving a second photographing instruction; and
acquiring a second frame of exposure image data collected by the camera set, synthesizing the first frame of exposure image data at the first preset ratio and the second frame of exposure image data at the second preset ratio according to the double exposure algorithm, and generating a compressed coded picture according to exposure image data synthesized.

7. The electronic device according to claim 6, wherein the processor is further configured to perform:
caching the first frame of exposure image data after the camera set collects the first frame of exposure image data; and
caching the second frame of exposure image data after the camera set collects the second frame of exposure image data.

8. The electronic device according to claim 7, wherein the processor is further configured to perform:
releasing the first frame of exposure image data and the second frame of exposure image data.

9. The electronic device according to claim 6, wherein the processor is further configured to perform:
adjusting the first preset ratio before the second instruction receiving module.

10. The electronic device according to claim 6, wherein the double exposure algorithm comprises a calculation formula as follows:
P=M*P1+(1−M)*P2
wherein P is the synthesized exposure image data, P1 is the first frame of exposure image data, P2 is the second frame of exposure image data or each frame of exposure image data obtained through live view finding of the camera set, M is the first preset ratio, and (1−M) is the second preset ratio, wherein 0<M<1.

11. A non-transitory computer readable medium, having computer programs stored thereon that, when executed by one or more processors of an electronic device, cause the electronic device to perform:
operating a shooting mode of the electronic device;
receiving a first photographing instruction;
acquiring a first frame of exposure image data collected by a camera set, synthesizing the first frame of exposure image data at a first preset ratio and each frame of exposure image data obtained through live view finding of the camera set at a second preset ratio in real time according to a double exposure algorithm, and displaying synthesized exposure image data on a shooting preview interface, a sum of the first preset ratio and the second preset ratio being 1;
receiving a second photographing instruction; and
acquiring a second frame of exposure image data collected by the camera set, synthesizing the first frame of exposure image data at the first preset ratio and the second frame of exposure image data at the second preset ratio according to the double exposure algorithm, and generating a compressed coded picture according to the synthesized exposure image data.
